(19) United States
(12) Patent Application Publication
(10) Pub. No.: US 2006/0100412 A1
(43) Pub. Date: May 11, 2006

(54) Phenol urea/melamine formaldehyde copolymers, method for the production thereof and use of the same

(75) Inventors: Kerstin Schmidt, Braunschweig (DE); Dirk Grunwald, Braunschweig (DE); Helmut Miertzsch, Wolfenbuettel (DE)

Correspondence Address: GREENBLUM & BERNSTEIN, P.L.C., 1950 ROLAND CLARKE PLACE, RESTON, VA, 20191, US

(73) Assignee: Fraunhofer-Gesellschaft zur Foerderung der Angewandten Forschung E.V., Muenchen (DE)

(21) Appl. No.: 10/546,949

(22) PCT Filed: Feb. 27, 2004
(86) PCT No.: PCT/DE04/00372

§ 371 Date: Sep. 29, 2005

(30) Foreign Application Priority Data
Feb. 28, 2003 (DE) 103 08 792.3
Apr. 23, 2003 (DE) 103 18 365.5

(51) Int. Cl. C08G 8/04; C08G 12/04; C08L 61/00

(52) U.S. Cl. 528/129; 528/211; 528/266

(57) ABSTRACT

The invention relates to phenol urea/melamine formaldehyde copolymers which can be obtained through the condensation of an aqueous precondensate of phenol and/or phenol derivatives with an aqueous precondensate of urea and/or urea derivatives and/or melamine and/or melamine derivatives and formaldehyde in the presence of an anionic ion exchanger and a cationic ion exchanger. Thereby in the first step urea and phenol are reacted with formaldehyde in separate reactions. The reaction is regulated by time, pH value and temperature such that only methylol ureas or methylol phenols are formed. In the next step the two reaction mixtures are combined and come into contact with the immobilized ion exchanger (which can also be used catalytically).

### TECHNICAL FIELD

The invention relates to phenol urea/melamine formaldehyde copolymers, a method for their production and the use of these copolymers. The copolymers or polycondensation resins according to the invention are preferably used for producing wooden materials or further processing wood or wooden materials.

### PRIOR ART

With duroplastic adhesives which are obtained through polycondensation, two important bond classes should be distinguished:

Firstly, aminoplastic adhesives, such as urea formaldehyde adhesives (referred to below as UF adhesives) or melamine urea formaldehyde adhesives (referred to below as MUF adhesives).

Secondly, phenolplastic materials, such as phenol formaldehyde adhesives (referred to below as PF adhesives) and phenol resorcinol formaldehyde adhesives (referred to below as PRF adhesives).

Both adhesives are used, i.a., in the field of friction linings and grinding layers, coatings, insulating materials and foundry auxiliaries. Furthermore, both bond classes are exceptionally important particularly in the field of wood and wooden materials. Many different types of materials can be bonded to one another with the aid of these adhesives.

The most important representatives of aminoplastic adhesives are UF adhesives and the most important representatives of phenoplastic adhesives are PF adhesives.

UF adhesives are produced according to a three-step synthetic pathway. In the first step, a low-molecular precondensate is produced from the components formaldehyde and urea under alkaline conditions (pH value 8-10) at temperatures between 50° C. and 90° C. in a discontinuous stirred reactor. Different alkali and alkaline earth hydroxides (NaOH, KOH, Ca(OH)₂) or amines can be used as catalysts. The molar ratio of urea formaldehyde is between 1:1.8 to 1:2.2. Depending on conditions, above all mono-, di- and trimethylol urea and other low-molecular methylol ureas are formed in this phase. Subsequently, a second polycondensation takes place under acid conditions (pH value 3-5). Many different types of organic or inorganic acids (e.g., sulfuric acid, phosphoric acid, formic acid, acetic acid, oxalic acid, etc.) can be used as catalysts. The reaction is terminated depending on the water compatibility or the viscosity by reducing the temperature (e.g., from 90° C. to 50° C. and/or shifting the pH value (to pH 8-10) and/or adding urea. Subsequently, a last addition of urea can take place at temperatures at or below 50° C. The final molar ratio of urea (referred to below as U) to formaldehyde (referred to below as F) is thus established between 1:0.95 and 1:1.2. The last addition of urea can also take place staggered in several steps or in part also during the condensation. The entire reaction can take place discontinuously and continuously in several stirred vessels or a stirred vessel cascade.

Both an acid and an alkaline condensation are possible to produce PF adhesives.

In the case of acid condensation of phenol (like phenol derivatives, referred to below as P) with formaldehyde, the components are reacted with one another in a molar ratio of 1:1. Above all linear polymers (novolaks) are formed hereby, which cannot be used as adhesive until after the addition of a cross-linker (curing agent) such as, e.g., formaldehyde, paraformaldehyde or hexamethylene tetramine.

In the case of alkali condensation, the formaldehyde content is much higher (molar ratio P:F approx. 1:2 to 1:3). Under the influence of an alkaline catalyst (e.g., on the basis of sodium hydroxide, barium hydroxide, tertiary amines or ammonia), the so-called resols form, which can be used as an adhesive. The alkaline catalyst is not added in traces, but in much larger quantities.

PF adhesives show a good water-dilutability and storage stability. The resols produced in an alkaline manner almost exclusively are used as adhesives. After the addition of the three reaction components (P, F, alkali), firstly methylolation of the phenol occurs, analogous to the UF adhesives. However, in terms of industrial engineering this methylolation is separated from the subsequent condensation via the temperature, not via the pH value. Methylolation occurs at temperatures about 50° C., which seamlessly changes into the condensation with a further increase in temperature. For condensation, the reaction optimum lies at about 90° C. The reaction is terminated depending on the water compatibility or the viscosity by temperature reduction. Usually PF adhesives are produced industrially in a discontinous manner (i.e., by batch operation).

PF adhesives have the disadvantages of a dark color (i.e., an unwanted optical impression), have a relatively high price and exhibit a low reactivity compared with UF adhesives. Furthermore, the alkaline content of the PF adhesives complicates the subsequent coating (e.g., with acid-hardening melamine-resin impregnating films). The alkaline content of the PF adhesives furthermore has the disadvantage that when these PF adhesives are used in wooden material panels, the compensating moisture of the panel is increased, whereby the danger of biological damage to the wooden material panel is likewise increased.

UF adhesives are characterized by a light, almost transparent color, so that the adhesive joint is not optically discernible in most applications. Moreover, they are cheaper than PF adhesives and have a relatively high reactivity. However, they have the disadvantage of a low hydrolytic stability and associated formaldehyde emissions.

In an effort to combine the positive properties of UF and PF adhesives and to eliminate the adverse properties, attempts were made to develop phenol urea formaldehyde adhesives (referred to below as PUF adhesives).

DE 196 53 628 A1 describes the reaction of a phenol formaldehyde condensation resin with urea and further formaldehyde under alkaline conditions. B. Tomita et al. (Holzforschung 48, 1994, 522ff) describes the reaction of a precondensate of urea and formaldehyde which contains a formaldehyde surplus with phenol under acid conditions.

However, both methods have the disadvantage that a substantial amount of unincorporated monomers, i.e., urea or phenol, is present in the polycondensate obtained.

### DESCRIPTION OF THE INVENTION

The object of the present invention is therefore to overcome the disadvantages of the prior art and to disclose a copolymer of urea, formaldehyde and phenol in which the fullest possible incorporation of all monomers in the adhesive matrix is available.

This technical problem is solved by a copolymer according to claim 1 and the method for its production according to claim 14. Claims 15, 17 and 18 specify advantageous uses, subordinate claims teach advantageous further developments.

The copolymer according to the invention can be obtained through condensation of an aqueous precondensate of phenol and/or phenol derivatives (referred to below as PF precondensate) with an aqueous precondensate of urea and/or urea derivatives and/or melamine and/or melamine derivatives (referred to below as UF or MF or MUF precondensate) and formaldehyde or a formaldehyde derivative in the presence of an immobilized catalyst which contains a matrix that can release H⁺ ions and an immobilized catalyst which contains a matrix that can release OH⁻ ions or an immobilized catalyst which contains a matrix that can release OH⁻ ions and H⁺ ions.

A mixture of an anionic ion exchanger and a cationic ion exchanger as an immobilized catalyst is preferred, but other (immobilized) substances (e.g., zeolites) or biomolecules which can release OH⁻ ions or H⁺ ions are also suitable.

To produce the precondensates, in the first step urea or urea derivative and phenol or phenol derivative are reacted with formaldehyde in separate reactions. The reaction is controlled by time, pH value and temperature such that only methylol ureas or methylol phenols are formed. In the next step, the two reaction batches are combined and come into contact with the immobilized catalyst. The immobilized catalyst is preferably used catalytically. The condensation is carried out with the setting of a suitable reaction temperature and reaction time. In a last step the so-called postcondensation can be carried out. The important project properties such as viscosity, solids content, reactivity and storage stability are thereby set.

The copolymers according to the invention contain no detectable or only just slight amounts of monomers. This can be verified by means of gel permeation chromatography (GPC) and NMR spectroscopy (¹³C-NMR).

The copolymers according to the invention therefore have the advantage that no amounts or only small amounts of latent acids as anions (e.g., formates, acetates or hydrogen phosphates) or no amounts or only small amounts of alkali are contained in the adhesive or in a cured adhesive joint. For example, acid residues in interaction with wood acids always present can mechanically damage the adhesive joint in wooden materials, reduce their long-term stability, increase the hydrolysis sensitivity and intensify the formaldehyde release. As already mentioned above, alkali residues increase the compensating moisture of a wooden material panel.

Furthermore, the copolymers according to the invention have the advantage that a regeneration of the catalyst is possible. The catalyst used in the condensation of the precondensates is heterogeneous and can therefore be separated from the reaction mixture that moves past this immobilized catalyst. Finally, it is also sufficient to use only small amounts of catalyst, whereby the hydrolysis sensitivity of the adhesives is further improved.

Furthermore, the polycondensation can be more easily controlled through the use of the immobilized catalysts. To produce UF or PF adhesives, the condensation takes place with the release of energy (this is an exothermal reaction). Heat is thus released which additionally accelerates the reaction. Effective regulating and cooling devices are therefore necessary during the production of UF and PF adhesives. These reactions for the production of UF or PF adhesives are very difficult to keep under control, but can be regulated through the addition of additional alkaline or acid catalysts. However, this has the disadvantage of additional acid or alkaline contents in the polycondensation resins forming. Through the use of immobilized catalysts, this problem cannot occur with the method according to the invention, so that an uncontrolled increase in the reaction temperature can be ruled out and nevertheless no undesirable acid or alkaline residues remain in the polycondensation resin obtained.

For the PUF adhesives according to the invention, for the production of the PF precondensate the phenol or phenol derivatives are preferably selected from the following compounds: unsubstituted phenol, phenol derivatives substituted with linear or branched alkyl groups (in particular o-, m-, p-cresol, p-tert-butylphenol, p-tert-octylphenol, p-tert-nonylphenol, 2,3-dimethylphenol, 2,4-dimethylphenol, 2,5-dimethylphenol, 2,6-dimethylphenol or 3,5-dimethylphenol), compounds which contain several phenol units (in particular bisphenol A and bisphenol F), resorcinol and resorcinol derivatives, pyrolysis oils, tannins, lignins and cashew nut shell liquid (CNSL).

Unsubstituted phenol and mixtures that contain over 95 mol % unsubstituted phenol (in particular mixtures with resorcinol and/or bisphenol A) are particularly preferred.

The urea or the urea derivative used in the production of UF or MUF precondensate is preferably selected from the following compounds: unsubstituted urea, derivatives of urea which contain alcohol groups (in particular monomethylol urea and dimethylol urea), urea derivatives substituted with alkyl groups (in particular methyl urea).

Unsubstituted urea is particularly preferred.

The melamine or the melamine derivative used in the production of the MF or MUF precondensate is preferably selected from the following compounds: unsubstituted melamine and salts of melamine (in particular acetates, formates, lactates and oxalates).

Unsubstituted melamine is particularly preferred.

The formaldehyde and/or formaldehyde derivative used for the production of the PF precondensate or PF or MF or MUF precondensate is preferably selected from the following compounds:

unsubstituted formaldehyde, compounds that can release formaldehyde (in particular paraformaldehyde, trioxane, polyoxymethylene, hexamethylenetetramine) and aldehydes (in particular acetaldehyde, butyraldehyde and furfurylidene).

Unsubstituted formaldehyde is particularly preferred.

The copolymers produced according to the invention can additionally contain, depending on the application, fillers, pigments, softeners, bonding agents, solvents and/or non-reactive polymers or non-reactive oligomers. Furthermore, they can contain insecticides and/or microbicides (e.g., commercially available fungicides). The copolymers can be applied in liquid or in powder form. To produce the powder form, a drying in the falling-film evaporator or spray drier can take place.

If a higher viscosity is necessary for further processing, substances can be added which increase the same (e.g., emulsifiers or carboxymethylcellulose).

Preferred uses of the copolymers according to the invention lie in the production or further processing of wood or wooden materials (e.g., wood fiber boards and particle boards) in particular as an adhesive, binder, glue or foundry auxiliary. The production of wooden materials is described, e.g., in Ullmanns Enzyklopädie der technischen Chemie, 4^{th} ed., volume 12, p. 709 ff.

Further possible applications of the copolymers according to the invention lie in the use as a binder in grinding wheels and as a binder in insulating materials, in the production of foam resins and in a use as an impregnating resin.

In a preferred embodiment the phenol urea formaldehyde copolymers or phenol melamine formaldehyde copolymers according to the invention are obtained through the condensation
a) of an aqueous precondensate of phenol and/or one or more phenol derivatives (P) and of formaldehyde and/or a formaldehyde derivative (F) (PF precondensate) in a molar ratio (P:F) of 1:1 to 1:5, preferably 1:2 to 1:3
b) of an aqueous precondensate of urea and/or one or more urea derivatives (U) and/or melamine and/or one or more melamine derivatives (M) and formaldehyde and/or a formaldehyde derivative (UF or MF or MUF precondensate) in a molar ratio (U:F or M:F or (U+M):F) of 1:0.9 to 1:2.2, preferably 1:1.3 to 1:2.
c) in the presence of immobilized catalysts which release OH⁻ ions and H⁺ ions (preferably a mixture of anionic with cationic ion exchangers) which catalyze the condensation, preferably at a temperature from 30 to 100° C., particularly preferably approx. 90° C. and if necessary with
d) subsequent condensation in a separate reaction chamber under alkaline or acid conditions preferably at a temperature from 30 to 100° C., particularly preferably 90° C. and if necessary the addition of further monomers.

Instead of carrying out a condensation under alkaline or acid conditions, in step d) a cross-linker (in particular a cross-linker that reacts with free OH groups) can also be added or the sample can be cured through increased temperatures. A combination of condensation under alkaline or acid conditions and the addition of a cross-linker is also possible.

The condensation according to c) or d) is advantageously conducted until the necessary viscosity (preferably 200-800 mPas) has been reached. Step d) can be omitted completely for the production of impregnating resins.

The copolymer of the above preferred embodiment is characterized in that its molar composition can be varied within the following limits: phenol:urea:melamine:formaldehyde: 0.0-1:0.0-1:0.0-1:0.0-3. A real copolymer is hereby present, i.e., both urea and phenol are integrated into the polymer body. It was possible to verify through gel permeation chromatography (GPC) that the monomer content is clearly below 5%, usually even below 1%. The bond formation between urea and phenol takes place via methylene bridges. It was possible to verify this through ¹³C-NMR spectroscopy. The polymer thus differs clearly from known technical systems such as PF/U and PF/UF mixtures.

The PF, UF, MF and MUF precondensates are preferably produced such that no oligomers or only a few oligomers (preferably less than 10% by weight, very particularly preferably less than 5% by weight) are contained, i.e., that the precondensates apart from these oligomers comprise only methylolated monomers (in particular mono-, di- and trimethylol urea, mono-, di- and trimethylol phenol, mono-, di- and trimethylol melamine or single to triple methylolated derivatives of these compounds). The reaction to produce the precondensate therefore preferably takes place in an aqueous solution at pH values between 5 and 9.

The production of the PF precondensates takes place particularly preferably at pH values between 7 and 9, very particularly preferably at pH 8 Moreover, a reaction temperature between 15° C. and 90° C., particularly room temperature (approx. 20-25° C.) is preferred.

The production of the UF, MF and MUF precondensates takes place particularly preferably at pH values between 5 and 7, very particularly preferably at pH 6. Moreover, a reaction temperature between 15° C. and 60° C., particularly preferably room temperature (approx. 20-25° C.) is preferred.

In order to obtain copolymers with particularly low monomer contents according to the invention, the pH value of the combined PF, UF, MF and MUF precondensates before the addition of the immobilized catalysts is 6.5 to 7.5.

The method according to the invention for the production of the copolymers can be carried out continuously and discontinuously. In the continuous method the reaction is preferably controlled such that the polymerization degree of the addition resin according to the invention at the end of the first condensation step is so high that the active centers of the immobilized catalyst just do not agglutinate. Advantageously, therefore a temperature gradient (from low temperature to higher temperatures) can be applied when the mixture of the precondensates passes through the zone of the immobilized catalyst and thereby reacts to the addition products according to the invention. Furthermore, several zones with immobilized catalysts can be connected in series or a zone can be passed through several times, whereby if necessary the temperature in these zones increases.

The postcondensation (or second condensation) of the addition products according to the invention can preferably take place through the addition of a cross-linker or of fillers which increase the degree of polymerization (e.g., also chips or wood fibers).

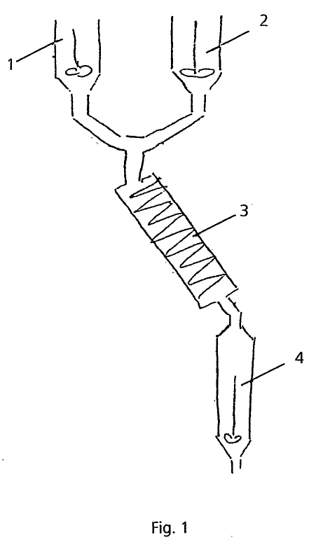

FIG. 1 shows the technical sequence of the method for producing the copolymers according to the invention. (1) is thereby a reaction vessel for producing the PF precondensate, (2) is a reaction vessel for producing the UF, MF or MUF precondensate, (3) is the reaction chamber in which the polycondensation of the combined precondensates takes place in the presence of an immobilized catalyst and (4) is a reaction chamber in which if necessary a postcondensation can be carried out.

### APPLICATION EXAMPLES

Without loss of generality, the invention is described in more detail below on the basis of examples:

### Example 1

PF precondensate: 203 ml (2.5 mol) formaldehyde solution (37%) is mixed with 13.28 g sodium hydroxide and stirred until a clear solution is formed. 94.11 g (1 mol) phenol is added. The reaction mixture is heated to 90° C. and the temperature is maintained for 15 min. The precondensate is cooled to room temperature.

UF precondensate: 60.6 g (1 mol) urea is added to 162.3 ml (2 mol) formaldehyde solution (37%). The reaction mixture is heated to 40° C. for 2 min. and then cooled to room temperature.

Copolymerization: The two precondensates are combined and the mixture is adjusted to pH 7. 4 g of an anion exchanger (charged with OH⁻ ions) and 2 g of a cation exchanger (charged with H⁺ ions) is added. The reaction mixture is heated to 90° C. for approx. 1 hour.

After the viscosity has been reached, the catalyst is separated from the reaction mixture by filtration.

A PUF condensate is obtained which contains less than 5% of the monomers used as educt. Confirmation by means of GPC (gel permeation chromatography) and NMR.

### Examples 2-4

Examples 2-4 were carried out analogously to example 1. The following molar ratios were set.

| Example | UF Precondensate | PF Precondensate |
|---|---|---|
| 2 | 1 mol urea | 1 mol phenol |
| | 2 mol formaldehyde | 2 mol formaldehyde |
| 3 | 1 mol urea | 1 mol phenol |
| | 2 mol formaldehyde | 3 mol formaldehyde |
| 4 | 1 mol urea | 1 mol phenol |
| | 1.5 mol formaldehyde | 2 mol formaldehyde |

A PUF condensate is obtained which contains less than 5% of the monomers used as educt. (Confirmation by means of GPC and NMR).

### Example 5

PF Precondensate: 5 mol formaldehyde solution (37%) is mixed with 16 ml 0.1 mol sodium hydroxide solution and stirred until a clear solution is formed. 2 mol phenol is added. The reaction mixture is heated to 90° C. and the temperature is maintained for 10-20 minutes. The precondensate is cooled to room temperature.

UF precondensate: 4 mol formaldehyde solution (37%) is set at pH3. Subsequently 2 mol urea is added. The reaction mixture is mixed for several minutes.

Copolymerization: The two precondensates are combined and the mixture is adjusted to pH7. The mixture is sent 13 times over a column with a mixture of 20 g of an anion exchanger (IRA67) (charged with OH⁻ ions) and 10 g of a cation exchanger (IRC50) (charged with H⁺ ions).

To remove excess formaldehyde and water, the reaction product obtained is vacuum distilled at 110 mbar and 60° C. until a solids content of approx. 43-49% is obtained.

The PUF condensate obtained contains less than 5% of the monomers used as educt.

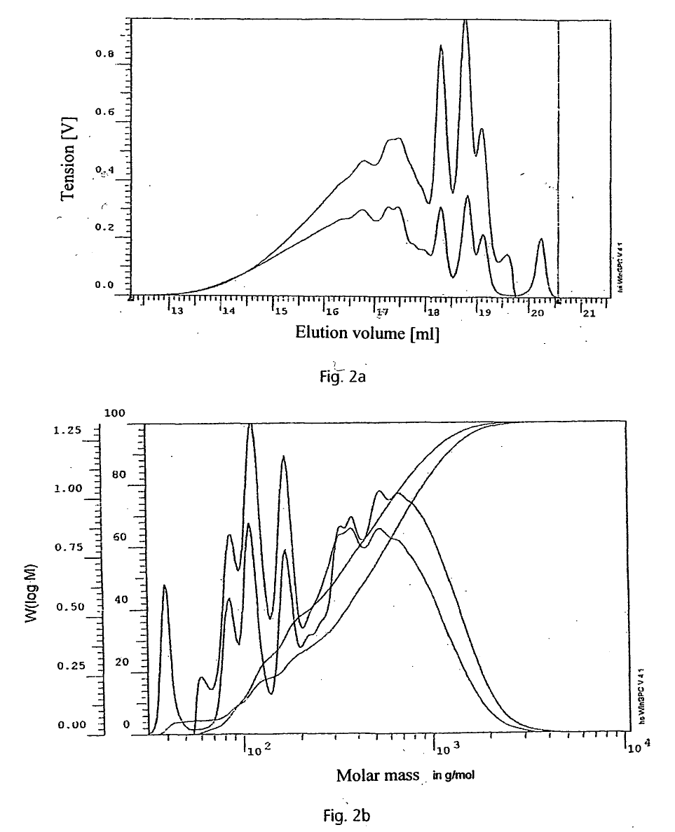

FIG. 2a shows the GPC diagram: hereby the upper curve is an RI detection in which the urea groups are detected, the lower curve is a UV detection in which the phenol groups are detected. At the right edge of the spectrum at 20.2 ml unreacted phenol and at 19.5 ml unreacted urea can be seen.

FIG. 2b shows the same spectrum in which the elution volume was transformed for the molar mass distribution. Furthermore, lines disclosing the percentage molar distribution of the reaction product run through the spectrum. It is hereby discernible that only approx. 4% unreacted phenol and approx. 1% unreacted urea are contained.

FIG. 4 shows the ¹³C-NMR spectrum (recorded in d⁶-DMSO) in the range of 34-95 ppm.

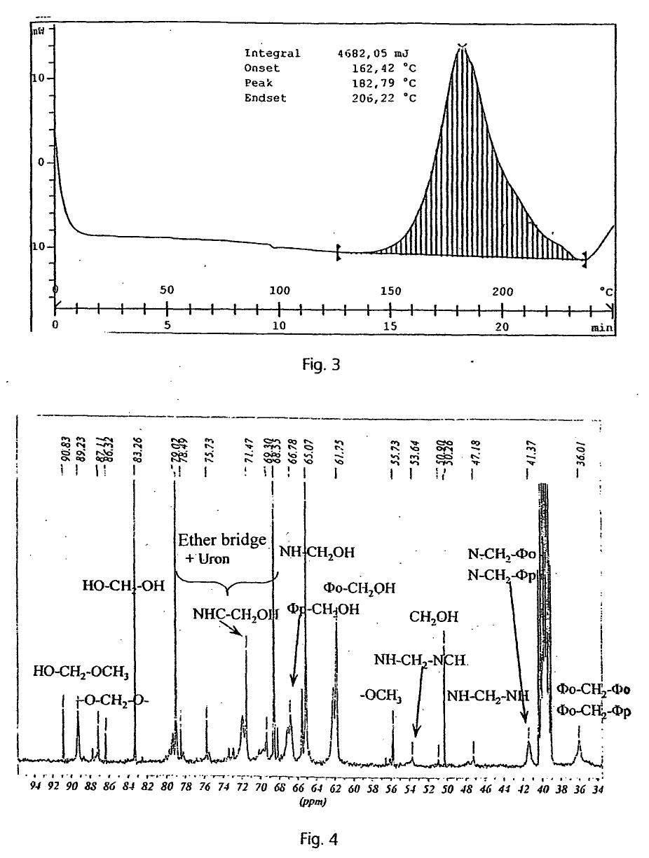

FIG. 3 shows the DSC diagram of the reaction product obtained (which has a low degree of cross-linking). Without the addition of a cross-linker, at pH 7 a curing peak is obtained at approx. 183° C.

1. A copolymer produced by the process comprising:
a first condensation on an aqueous precondensate of phenol and/or one or more phenol derivatives (P) and/or formaldehyde and/or a formaldehyde derivative (F);
an aqueous precondensate of urea and/or one or more urea derivatives (U) and/or melamine and/or one or more melamine derivatives (M) and formaldehyde and/or a formaldehyde derivative;
in the presence of an immobilized catalyst which can release H⁺ ions and of an immobilized catalyst which can release OH⁻ ions or of an immobilized catalyst which can release OH⁻ ions and H⁺ ions.

2. The copolymer according to claim 1, wherein the molar ratio P:F is 1:1 to 1:5.

3. The copolymer according to claim 1, wherein the molar ratio U:F or M:F or (U+M):F is 1:0.9 to 1:2.2.

4. The copolymer according to claim 1, wherein the first condensation is carried out in the presence of an anionic ion exchanger and a cationic ion exchanger as immobilized catalysts.

5. The copolymer according to claim 1, wherein the first condensation is carried out at a temperature of 30 to 100° C.

6. The copolymer according to claim 1, wherein a catalytic amount of the ion exchanger is used.

7. The copolymer according to claim 1, wherein a second condensation under alkaline or acid conditions in which no ion exchanger is present, is downstream of the first condensation.

8. The copolymer according to claim 1, wherein a second condensation is downstream in which a cross-linker and/or a filler that increases the degree of polymerization is added.

9. The copolymer according to claim 7, wherein the second condensation takes place at a temperature of 30 to 100° C., and if necessary with the further addition of monomers (P, M, U and/or F).

10. The copolymer according to claim 1, wherein the copolymer has a viscosity corresponding to the application.

11. The copolymer according to claim 1, wherein the molar composition based on the educts can be varied in the following limits: (P):(U):(M):formaldehyde=0.0 to 1:0.0 to 1:0.0 to 1:1-3.

12. The copolymer according to claim 1, wherein the amount of unreacted monomers is less than 5%.

13. The copolymer according to claim 1, wherein additionally fillers, pigments, softeners, bonding agents, solvents and/or non-reactive polymers or non-reactive oligomers are contained.

14. Method for producing a copolymer through the condensation of an aqueous mixture comprising, containing phenol and/or one or more phenol derivatives (P) and/or urea and/or one or more urea derivatives (U) and/or melamine and/or one or more melamine derivatives (M) and formaldehyde in the presence of an anionic ion exchanger and a cationic ion exchanger.

15. The copolymer according to claim 1, wherein the copolymer is further processed with wood or wooden materials.

16. The copolymer according to claim 15, wherein the copolymer comprises adhesive, binder, glue or foundry auxiliary.

17. The copolymer according to claim 1, wherein the copolymer comprises a binder in grinding disks.

18. The copolymer according to claim 1, wherein the compolymer comprises at least one of a binder in insulating materials, an intermediate in the production of foam resins, and an impregnating resin.

19. The copolymer according to claim 2, wherein the molar ration P:F is 1:2 to 1:3.

20. The copolymer according to claim 3, wherein the molar ration U:F or M:F or (U+M):F is 1:1.3 to 1:2.

21. The copolymer according to claim 5, wherein the first condensation is carried out at a temperature of about 90° C.

22. The copolymer according to claim 7, wherein the second condensation takes place at a temperature 90° C. and if necessary with the further addition of monomers (P, M, U and/or F).

23. The copolymer according to claim 1, wherein the copolymer has a viscosity between 200-800 mPas.

24. The copolymer according to claim 1, wherein the amount of unreacted monomers is less than 1%.
